(19) United States
(12) Patent Application Publication
(10) Pub. No.: US 2017/0195997 A1
(43) Pub. Date: Jul. 6, 2017

(54) BASE STATION AND USER TERMINAL

(71) Applicant: KYOCERA CORPORATION, Kyoto (JP)

(72) Inventors: Noriyoshi FUKUTA, Tokyo (JP); Chiharu YAMAZAKI, Tokyo (JP)

(73) Assignee: KYOCERA CORPORATION, Kyoto (JP)

(21) Appl. No.: 15/463,727

(22) Filed: Mar. 20, 2017

Related U.S. Application Data
(63) Continuation of application No. PCT/JP2015/076225, filed on Sep. 16, 2015.

(30) Foreign Application Priority Data
Sep. 26, 2014 (JP) 2014-197610

(51) Int. Cl. H04W 72/04; H04W 74/08; H04W 76/02; H04W 16/14; H04L 5/00

(52) U.S. Cl. CPC H04W 72/042; H04W 16/14; H04W 72/0453; H04W 72/0413; H04L 5/0055; H04L 5/0051; H04L 5/0048; H04W 76/025; H04W 74/0808

(57) ABSTRACT

A base station performs radio communication with a plurality of terminals in a specific frequency band in which frequency sharing among a plurality of communication operators and a plurality of radio communication systems is permitted. Part of a frequency region within the specific frequency band is set as a control-only region. The base station determines, by the carrier-sense in the specific frequency band, a data region for user data transmission, from a frequency region different from the part of the frequency region within the specific frequency band. The base station transmits or receives, in a control region R1, terminal-specific data control information for individually controlling a user data transmission of each terminal within the data region.

### RELATED APPLICATIONS

This application is a continuation application of international application PCT/JP2015/076225, filed Sep. 16, 2015, which claims benefit of Japanese Patent Application No. 2014-197610 (filed on Sep. 26, 2014), the entirety of all applications hereby expressly incorporated by reference.

### TECHNICAL FIELD

The present application relates to a base station and a user terminal used in a radio communication system.

### BACKGROUND ART

As a control scheme in a radio communication system, an autonomous distributed control and a centralized control are well known.

The autonomous distributed control is a scheme in which distributed terminals each operate autonomously without being affected by external control. The autonomous distributed scheme of the radio communication is employed, for example, in a PHS (Personal Handyphone System). The principle of the PHS is to automatically select and use a vacant frequency from a whole frequency allocated to the PHS, when the base station and the terminal perform communication. The autonomous distributed control does not require detailed cell design, thus extension of the base station becomes easier.

On the other hand, in addition to the autonomous distributed control of the radio communication, the centralized control is a scheme being employed as cellular communication represented by LTE (Long Term Evolution) and the like. The centralized control scheme requires cell design, and a specific frequency is allocated to each base station. When there is a request to connect from the terminal, a radio resource is allocated, from the frequency allocated to the base station, to the terminal (see Non-Patent Document 1, for example).

### PRIOR ART DOCUMENT

### Non-Patent Document

Non Patent Document 1: 3GPP Technical Specification “TS 36.300 v12.2.0” July, 2014

### SUMMARY

A case is assumed where a communication standard of a cell phone represented by the LTE or the like is used in a frequency band in which frequency sharing is permitted among a plurality of communication operators or a plurality of radio communication systems (hereinafter, referred to as a “specific frequency band”). The specific frequency band may be referred to as an unlicensed band or as a license shared access band.

In this case, incidence of large interference is possible between appliances of different radio communication scheme and different communication operators. This is because an existing LTE specification is defined assuming that the cell design is performed and an LTE base station operates to exclusively utilize the allocated frequency.

However, in the specific frequency band, the frequency sharing is permitted among a plurality of communication operators or a plurality of radio communication systems, and thus, it is practically impossible to perform cell design.

Therefore, an object of the present application is to provide a base station and a user terminal with which it is possible to enable operation by extending an existing LTE specification to perform autonomous distributed control without a need of cell design.

A base station according to a first aspect performs radio communication with a plurality of user terminals in a specific frequency band in which frequency sharing is permitted among a plurality of communication operators or a plurality of radio communication systems. A part of a frequency region within the specific frequency band is set as a control-only region. The base station comprises a controller configured to determine, by a carrier-sense in the specific frequency band, a data region for user data transmission, from a frequency region different from the part of the frequency region within the specific frequency band; and a transceiver configured to transmit or receive, in the control-only region, terminal-specific data control information for individually controlling a user data transmission of each user terminal within the data region.

A user terminal according to a second aspect performs radio communication with a base station in a specific frequency band in which frequency sharing is permitted among a plurality of communication operators or a plurality of radio communication systems. A part of a frequency region within the specific frequency band is set as a control-only region. A data region for user data transmission is determined, by a carrier-sense in the specific frequency band, from a frequency region different from the part of the frequency region within the specific frequency band. The user terminal includes a transceiver configured to transmit or receive, in the control-only region, terminal-specific data control information for individually controlling a user data transmission of each user terminal within the data region.

### BRIEF DESCRIPTION OF THE DRAWINGS

FIG. 1 is a diagram illustrating a configuration of an LTE system according to a first embodiment and a second embodiment.

FIG. 2 is a diagram illustrating a protocol stack a radio interface in an LTE system according to the first embodiment and the second embodiment.

FIG. 3 is a diagram illustrating a radio frame used in the LTE system according to the first embodiment and the second embodiment.

FIG. 4 is a diagram illustrating an operation environment according to the first embodiment and the second embodiment.

FIG. 5 is a diagram illustrating a resource allocation in a specific frequency band according to the first embodiment and the second embodiment.

FIG. 6 is a diagram illustrating a configuration of a control region according to the first embodiment and the second embodiment.

FIG. 7 is a block diagram of a base station according to the first and second embodiment.

FIG. 8 is a block diagram of a terminal according to the first embodiment and the second embodiment.

FIG. 9 is a flowchart illustrating an operation related to determination of a data region according to the first embodiment.

FIG. 10 is a flowchart illustrating a detail of an operation of the base station (step S200 of FIG. 9) related to a carrier-sense according to the first embodiment.

FIG. 11 is a flowchart illustrating a detail of a terminal operation (step S300 of FIG. 9) according to the carrier-sense according to the first embodiment.

FIG. 12 is a flowchart illustrating an operation related to an end of use of the data region according to the first embodiment.

FIG. 13 is a flowchart illustrating a method of determining a control region according to the second embodiment.

FIG. 14 is a diagram illustrating an operation related to a cross subframe scheduling according to the second embodiment.

### DESCRIPTION OF THE EMBODIMENT

[Overview of Embodiment]

A base station according to one embodiment performs radio communication with a plurality of user terminals in a specific frequency band in which frequency sharing is permitted among a plurality of communication operators or a plurality of radio communication systems. A part of a frequency region within the specific frequency band is set as a control-only region. The base station comprises a controller configured to determine, by a carrier-sense in the specific frequency band, a data region for user data transmission, from a frequency region different from the part of the frequency region within the specific frequency band; and a transceiver configured to transmit or receive, in the control-only region, terminal-specific data control information for individually controlling a user data transmission of each user terminal within the data region.

A user terminal according one embodiment performs radio communication with a base station in a specific frequency band in which frequency sharing is permitted among a plurality of communication operators or a plurality of radio communication systems. A part of a frequency region within the specific frequency band is set as a control-only region. A data region for user data transmission is determined, by a carrier-sense in the specific frequency band, from a frequency region different from the part of the frequency region within the specific frequency band. The user terminal includes a transceiver configured to transmit or receive, in the control-only region, terminal-specific data control information for individually controlling a user data transmission of each user terminal within the data region.

### First Embodiment

An embodiment of applying the present application to a radio communication system based on LTE specification (hereinafter referred to as “LTE system”) will be described below.

(System Configuration)

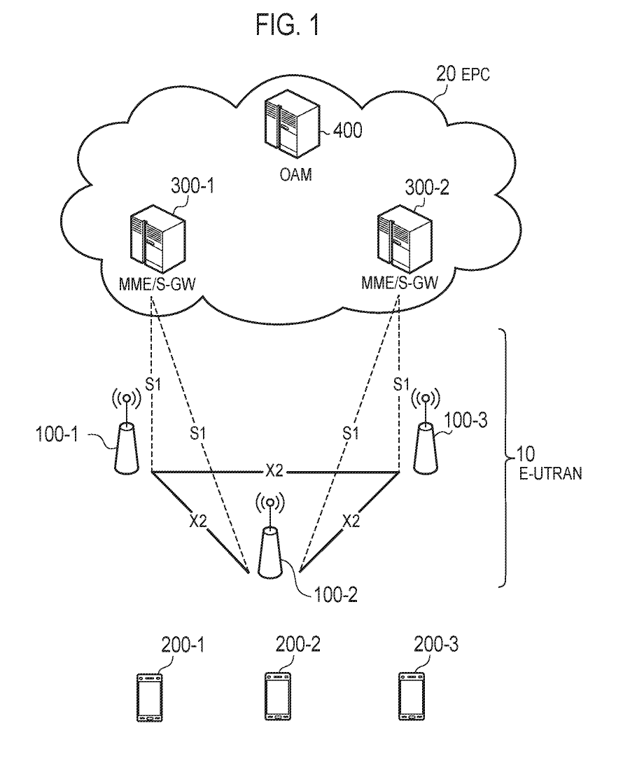

FIG. 1 is a diagram illustrating a configuration of the LTE system according to the first embodiment.

As illustrated in FIG. 1, the LTE system includes E-UTRAN (Evolved-UMTS Terrestrial Radio Access Network) 10, EPC (Evolved Packet Core) 20, and a plurality of user terminals (hereinafter referred to as “terminal”) 200.

The E-UTRAN 10 corresponds to a radio access network. The E-UTRAN 10 includes a plurality of base stations 100. The base stations 100 are interconnected via an X 2 interface. The base station 100 manages one or a plurality of cells and performs radio communication with the terminal 200 which establishes a connection with the cell of the base station 100. The base station 100 has a radio resource management (RRM) function, a routing function for user data, and a measurement control function for mobility control and scheduling, and the like. It is noted that the “cell” is used as a term indicating a minimum unit of a radio communication area, and is also used as a term indicating a function or resources of performing radio communication with the terminal 200. It is noted that the base station 100 may be referred as eNB (evolved Node-B). Configuration of the base station 100 will be described later.

The terminal 200 is a portable communication device and performs radio communication with the base station 100. It is noted that the terminal 200 may be referred to as UE (User Equipment) in some cases. Configuration of the terminal 200 will be described later

The EPC 20 corresponds to a core network. The EPC 20 includes a plurality of MME (Mobility Management Entity)/S-GWs (Serving-Gateways) 300. The MME performs various mobility controls and the like for the UE 100. The S-GW performs control to transfer user. MME/S-GW 300 is connected to eNB 200 via an S1 interface. The EPC 200 may include an OAM (Operation and Maintenance) 400. The OAM 400 is an apparatus that performs maintenance and monitoring of the E-UTRAN 10.

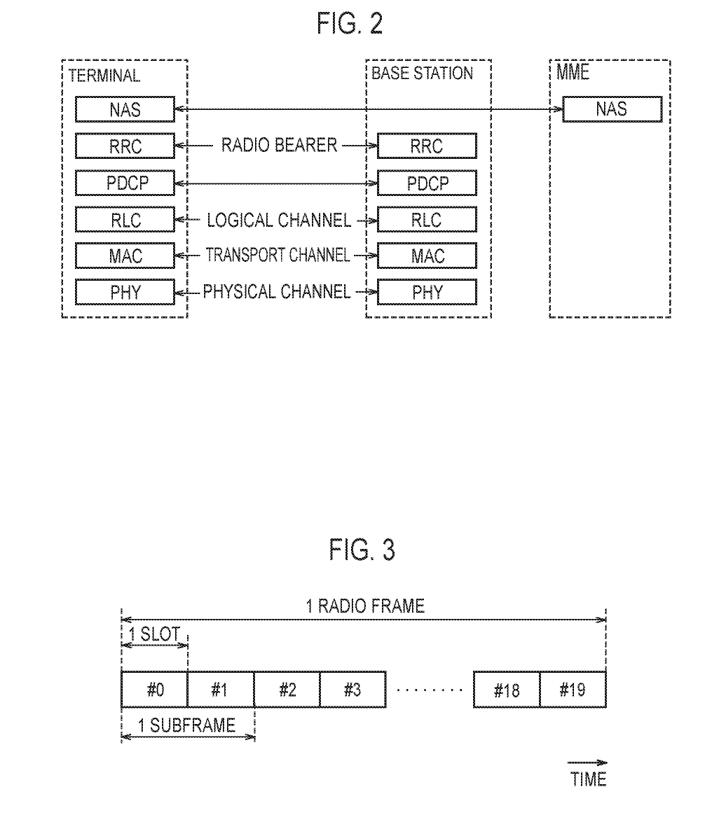

FIG. 2 is a protocol stack diagram of a radio interface in the LTE system.

As illustrated in FIG. 2, the radio interface protocol is classified into a layer 1 to a layer 3 of an OSI reference model, wherein the layer 1 is a physical (PHY) layer. The layer 2 includes a MAC (Media Access Control) layer, an RLC (Radio Link Control) layer, and a PDCP (Packet Data Convergence Protocol) layer. The layer 3 includes an RRC (Radio Resource Control) layer.

The PHY layer performs encoding and decoding, modulation and demodulation, antenna mapping and demapping, and resource mapping and demapping. Between the PHY layer of the terminal 200 and the PHY layer of the base station 100, user data and control signal are transmitted via the physical channel.

The MAC layer performs priority control of data, a retransmission process by hybrid ARQ (HARQ), and the like. Between the MAC layer of the terminal 200 and the MAC layer of the base station 100, user data and control signal are transmitted via a transport channel. The MAC layer of the base station 100 includes a scheduler that determines (schedules) a transport format of an uplink and a downlink (a transport block size and a modulation and coding scheme) and a resource block to be assigned to the terminal 200.

The RLC layer transmits data to an RLC layer of a reception side by using the functions of the MAC layer and the PHY layer. Between the RLC layer of the terminal 200 and the RLC layer of the base station 100, user data and control signal are transmitted via a logical channel.

The PDCP layer performs header compression and decompression, and encryption and decryption.

The RRC layer is defined only in a control plane dealing with control signal. Between the RRC layer of the terminal 200 and the RRC layer of the base station 100, control message (RRC messages) for various types of configuration are transmitted. The RRC layer controls the logical channel, the transport channel, and the physical channel in response to establishment, re-establishment, and release of a radio bearer. When there is a connection (RRC connection) between the RRC of the terminal 200 and the RRC of the base station 100, the terminal 200 is in a connected state, otherwise the terminal 200 is in an idle state.

A NAS (Non-Access Stratum) layer positioned above the RRC layer performs a session management, a mobility management and the like.

FIG. 3 is a configuration diagram of a radio frame used in the LTE system. In the radio communication system, OFDMA (Orthogonal Frequency Division Multiple Access) is applied to a downlink, and SC-FDMA (Single Carrier Frequency Division Multiple Access) is applied to an uplink, respectively. As a duplex scheme, either FDD (Frequency Division Duplex) or TDD (Time Division Duplex) is applied. However, in the first embodiment, the TDD scheme is mainly assumed.

As illustrated in FIG. 3, the radio frame is configured by 10 subframes arranged in a time direction, wherein each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. The resource block includes a plurality of subcarriers in the frequency direction. A resource element is constituted by one subframe and one symbol. Among radio resources (time-frequency resources) assigned to the UE 200, a frequency resource is constituted by a resource block and a time resource is constituted by a subframe (or slot).

In the downlink, an interval of several symbols at the head of each subframe is a control region used as a physical downlink control channel (PDCCH) for mainly transmitting downlink control information. Furthermore, the other interval of each subframe is a region available as a physical downlink shared channel (PDSCH) for mainly transmitting downlink user data. In the downlink, cell-specific reference signals (CRSs) are arranged and distributed in frequency direction and time direction.

In the uplink, both ends in the frequency direction of each subframe are control regions used as a physical uplink control channel (PUCCH) for mainly transmitting uplink control information. The remain portion of each subframe is a region available as a physical uplink shared channel (PUSCH) for mainly transmitting uplink user data.

(Operation Environment)

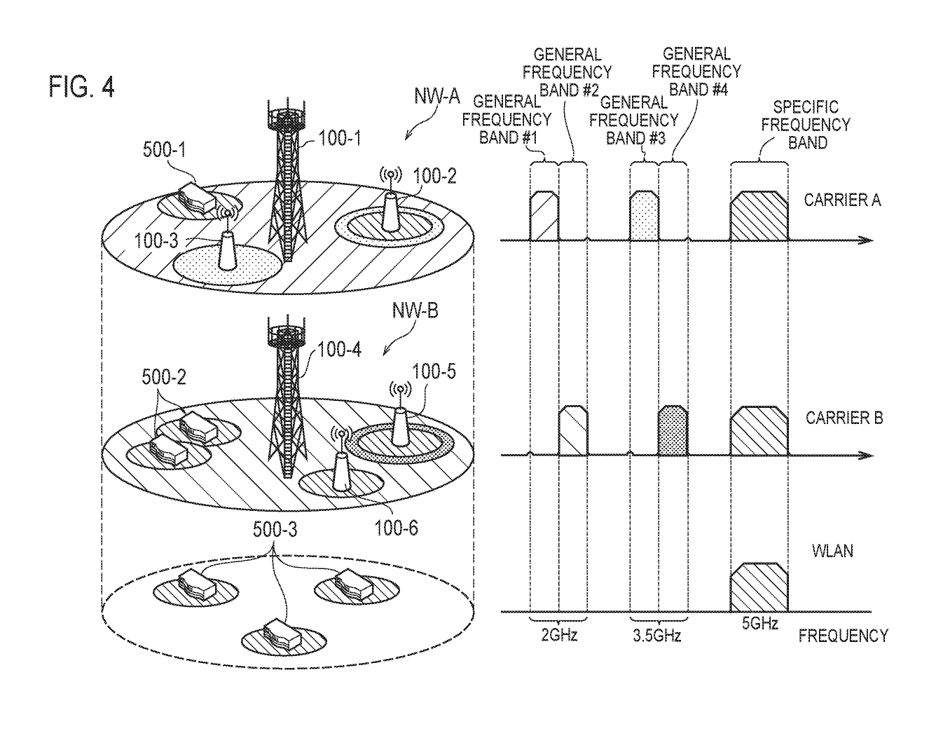

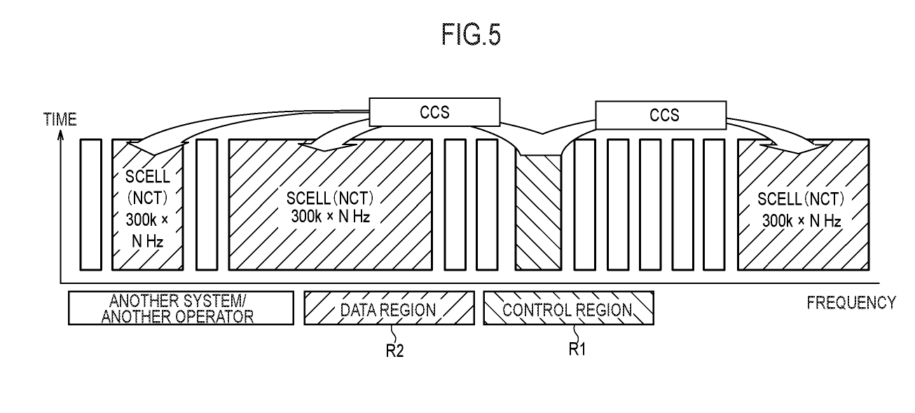

FIG. 4 is a diagram illustrating an operation environment according to the first embodiment.

As illustrated in FIG. 4, an NW-A is a network constructed by a communication operator (hereinafter, simply referred to as a “carrier”) A. An NW-B is a network constructed by a communication operator B. There are the NW-A and the NW-B in the same geographical location.

The NW-A is configured by a macro base station 100-1, a small base station 100-2, a small base station 100-3, and a WLAN AP500-1. The macro base station 100-1 has a cell (macro cell) operated in a general frequency band #1 allocated to the carrier A. The small base station 100-2 has a cell (small cell) operated in a general frequency band #3 allocated to the carrier A and a cell (small cell) operated in a specific frequency band. Here, the specific frequency band is a frequency band that enables frequency sharing among various appliances. The various appliances include at least a base station having the same scheme employed by another carrier. The small base station 100-3 has a cell operated in the general frequency band #3 allocated to the carrier A. The WLAN AP500-1 is an access point installed by the carrier A and is operated in the specific frequency band.

The NW-B is configured by a macro base station 100-4, a small base station 100-5, a small base station 100-6, and a WLAN AP500-2. The macro base station 100-4 has a cell (macro cell) operated in a general frequency band #2 allocated to the carrier B. The small base station 100-5 has a cell (small cell) operated in a general frequency band #4 allocated to the carrier B and a cell (small cell) operated in the specific frequency band. The small base station 100-6 has a cell operated in the specific frequency band. The WLAN AP500-2 is an access point installed by the carrier B and is operated in the specific frequency band.

In addition, in the same geographical location, there may be a WLAN AP500-3 operated in the specific frequency band. The WLAN AP500-3 may be a personally installed access point or a public access point. Naturally, an actual network is configured by a large number of other appliances.

In this way, in the specific frequency band, the frequency sharing among a plurality of carriers (the carrier A, the carrier B) or a plurality of radio communication systems (LTE system, WLAN system) is permitted.

(Resource Allocation in Specific Frequency Band)

FIG. 5 is a diagram illustrating a resource allocation in the specific frequency band according to the first embodiment. FIG. 5 illustrates an example in which a base station 100 implements a resource allocation to a terminal 200 while sharing a frequency with another radio communication system or another carrier (operator). Below, a case that the base station 100 is a small base station is primarily assumed.

As illustrated in FIG. 5, the base station 100 and the terminal 200 use a part of the specific frequency band as a control-only region (hereinafter, simply referred to as a “control region”) R1. Further, the base station 100 and the terminal 200 uses, as a data region R2, a frequency region that is available on the basis of a carrier-sense, out of the specific frequency band. A method of evaluating whether or not the region is available will be described later. The data region R2 is located in a region orthogonal, on the frequency, to the control region R1.

In the first embodiment, the control region R1 is a region known to the base station 100 and the terminal 200. The base station 100 transmits, in the control region, terminal-specific data control information for individually controlling user data transmissions of the terminals 200 respectively within the data region. The terminal 200 receives, in the control region, the data control information. The resource allocation technique may be referred to as a CSS (Cross Carrier Scheduling). It is noted that besides the Cross Carrier Scheduling, Cross Subframe Scheduling may be further applied. The Cross Subframe Scheduling will be described in a second embodiment.

The control region R1 may be notified to the terminal 200 from a cell operated in a non-specific frequency band provided in the base station 100. Alternatively, the control region R1 may be notified from another base station (macro base station and the like) to the terminal 200. It is noted that the terminal 200 is capable of a dual connectivity with a macro base station 101 and the base station 100. The dual connectivity is also referred to as a dual connectivity. The dual connectivity is described in detail in Non-Patent Document 1.

The base station 100 transmits, in the data region R2, user data to the terminal 200. The terminal 200 receives, the data region R2, the user data from the base station 100. In the first embodiment, a case is assumed where in the data region R2, a downlink user data transmission is performed. However, in the data region R2, in addition to the downlink user data transmission, an uplink user data transmission may be performed. In other words, on the basis of an instruction of the base station 100, the terminal 200 may transmit, in the data region R2, the user data to the base station 100.

It is noted that in cells operated in the general frequency band, the control region and the data region are arranged within the same frequency (carrier). For example, when transmitting the user data in a shared frequency (PDSCH region) shared among a plurality of terminals 200, the base station 100 transmits, in a shared frequency (PDCCH region), the terminal-specific data control information such as resource allocation information to each terminal 200.

On the other hand, in cells operated in the specific frequency band, the data region R2 is determined from an available frequency region, and thus, the control region is arranged in a frequency (carrier) different from the data region. That is, the base station 100 transmits the terminal-specific data control information such as the resource allocation information, by not using the frequency in which to transmit the user data, but by using a frequency different from the frequency in which to transmit the user data.

By using such a resource allocation scheme, operation is possible where the existing LTE specification is extended to enable autonomous distributed control without a need of performing cell design.

It is noted that the data region R2 may be used as a secondary cell (Scell) in a carrier aggregation (CA). The Scell may be referred to as a secondary component carrier (SCC). Further, the control region R1 may be used as a primary cell (Pcell) in the carrier aggregation. The Pcell may be referred to as a primary component carrier (PCC). In this case, in accordance with the carrier aggregation, the base station 100 and the terminal 200 simultaneously use the control region R1 (Pcell) and the data region R2 (Scell) to perform radio communication.

Further, a new carrier structure (NCT: New Carrier Type) may be applied to the data region R2 (Scell). In this case, the base station 100 may delete or omit the CRS in the data region R2 (Scell).

When the CRS in the data region R2 (Scell) is deleted or omitted, the base station 100 may transmit a channel state information reference signal (CSI-RS). In this case, the terminal 200 may perform, on the basis of CSI-RS, a CSI feedback on the base station 100. Therefore, the CRS is not used in the CSI feedback. It may suffice if a sufficient amount of CRS is transmitted for the measurement of RSRP (and RSRQ) by the terminal 200. It is noted that such a CRS may be referred to as a tracking reference signal (TRS) in the NCT. Transmission of the TRS is performed only from a predetermined antenna from among a plurality of antennas of the base station 100.

Further, in the data region R2 (Scell), the base station 100 transmits, together with the downlink user data, a demodulation reference signal (DMRS). The DMRS is a type of terminal-specific reference signal. It is noted that CSI-RS may be included in the terminal-specific reference signal. It is noted, although not specifically mentioned below, that the antenna may be interpreted as an antenna port.

(Configuration of Control Region)

It is preferable that the control region R1 is operated in a bandwidth with a backward compatibility with the existing LTE specification. Examples of the bandwidth with the backward compatibility with the existing LTE specification is 1.4 MHz, for example. The control region R1 is configured by PSS/SSS/TRS/(e)PDCCH, and transmits at least data control information needed for the user data transmission. PSS/SSS corresponds to a synchronization signal.

The control region R1 may also be further configured by CRS, DMRS, PBCH, PDSCH, and PUCCH. However, the PDSCH of the control region R1 is controlled so as not to be used for transmission of the user data. Information transmitted in the PDSCH of the control region is a type of data not possible to be determined as data addressed to a specific user in the physical layer, such as radio communication scheme information, paging information, and a random access response message. The PDSCH region may be referred to as FePDCCH (Further enhanced PDCCH).

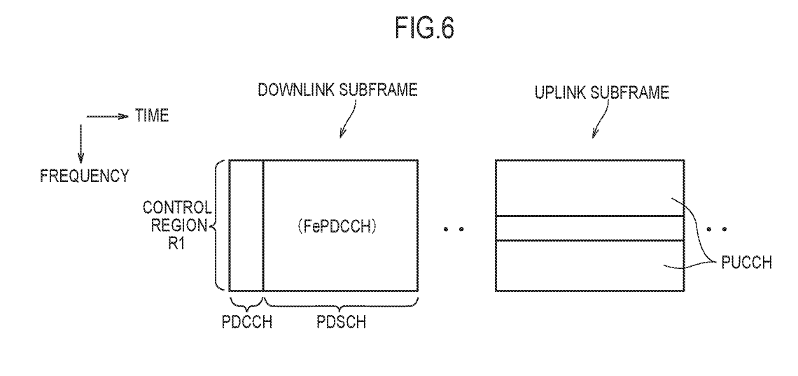

FIG. 6 is a diagram illustrating a configuration of the control region R1. FIG. 6 exemplifies a case in which the control region R1 is configured by a TDD frequency (TDD carrier).

As illustrated in FIG. 6, the control region R1 includes a plurality of subframes along a time axis. The plurality of subframes include a downlink subframe and an uplink subframe. The downlink subframe includes the PDCCH and the PDSCH. The PDCCH transports downlink control information (DCI). As described above, the PDSCH of the control region R1 configures the FePDCCH controlled not to be used for transmission of user data. The uplink subframe includes the PUCCH. PUCCH transports uplink control information (UCI).

In this way, in the control region R1, a transmission period of the downlink control information and a transmission period of the uplink control information are set in time division.

(Configuration of Base Station)

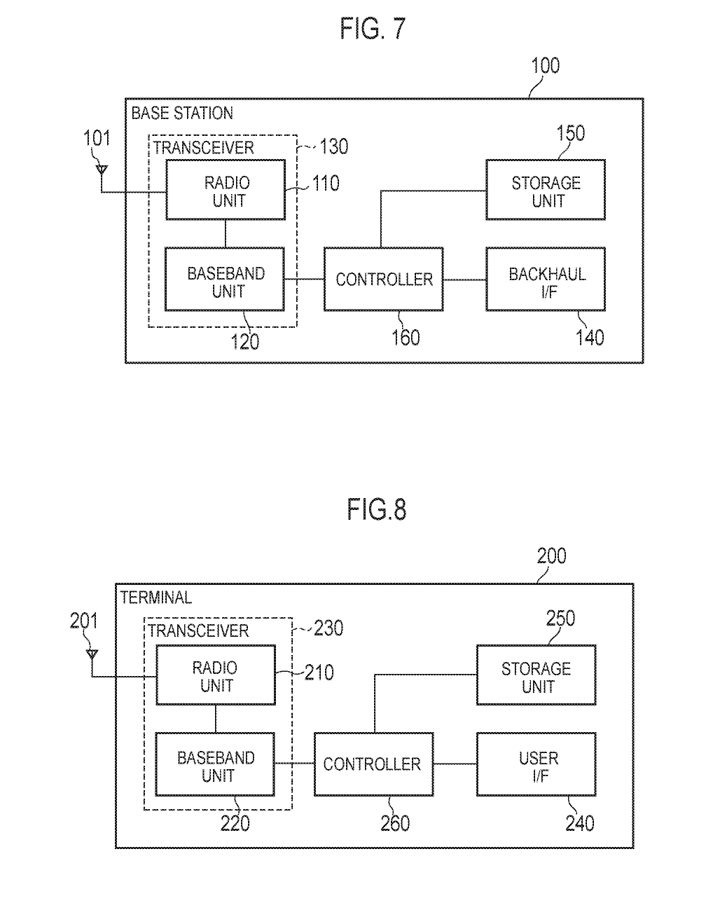

FIG. 7 is a block diagram of the base station 100 according to the first embodiment.

As illustrated in FIG. 7, the base station 100 includes an antenna 101, a radio unit 110, a baseband unit 120, a backhaul interface (I/F) 140, a storage unit 150, and a controller 160. The radio unit 110 and the baseband unit 120 configure a transceiver 130.

The antenna 101 and the radio unit 110 are used for exchanging a radio signal. The antenna 101 may be configured by a plurality of antennas. The baseband unit 120 converts a baseband signal (transmission signal) output from the controller 160 into a radio signal, and outputs the resultant signal to the radio unit 110. Further, the baseband unit 120 converts the radio signal received by the radio unit 110 into a baseband signal (reception signal) and outputs the resultant signal to the controller 160.

The backhaul I/F 140 is used for communication performed via a backhaul network. The backhaul I/F 140 is connected to a neighboring base station 100 via an X2 interface and is connected to the MME/S-GW 300 via an S1 interface.

The storage unit 150 is configured by a memory, for example, and stores a program executed by the controller 160 and information used for a process by the controller 160. The controller 160 is configured by a processor, for example, and executes various types of processes by executing the program stored in the storage unit 150.

An operation overview of the base station 100 thus configured will be described. In the first embodiment, the base station 100 performs radio communication with a plurality of terminals 200 in the specific frequency band in which the frequency sharing is permitted among a plurality of communication operators or a plurality of radio communication systems.

A part of the frequency region within the specific frequency band is set as the control region R1.

By the carrier-sense in the specific frequency band, the controller 160 determines the data region R2 for user data transmission, out of the frequency region different from the part of the frequency region within the specific frequency band. Here, the carrier-sense is a general term used for an operation to determine whether the frequency region in question is available or not, and does not refer to a specific technique. In the first embodiment, as a technique of the carrier-sense, a technique of evaluating whether or not the region is available depending on a received strength level is used. It is noted that the received strength level may be referred to as an interference level.

The transceiver 130 transmits or receives, in the control region R1, the terminal-specific data control information for individually controlling the user data transmission of each terminal 200 within the data region R2.

The terminal-specific data control information includes the downlink control information (DCI). The downlink control information includes resource allocation information, modulation and coding scheme (MCS) information, redundant version information, and a new data indicator within the data region R2. The transceiver 160 transmits, in the control region R1, the downlink control information.

Further, the terminal-specific data control information also includes the uplink control information (UCI). The uplink control information includes an acknowledgment (ACK/NACK) response to the user data transmitted in the data region R2, and channel state information (CSI) about the data region R2. The transceiver 160 receives the uplink control information in the control region R1. A period during which the downlink control information is transmitted and a period during which the uplink control information is received are set in time division.

In the first embodiment, the transceiver 160 transmits a synchronization signal in the control region R1, and transmits a terminal-specific reference signal in the data region R2. The synchronization signal may include a primary synchronization signal (PSS) and a secondary synchronization signal (SSS).

In the first embodiment, in the data region R2, the transceiver 160 transmits the cell-specific reference signal (CRS) at a predetermined time interval or omits the transmission of the cell specific reference signal. The predetermined time interval refers to a time interval shorter than the transmission time interval of the cell-specific reference signal in the base station 100 configured to perform the radio communication in the general frequency band. The cell-specific reference signal transmitted in the predetermined time interval may be transmitted only from a predetermined antenna. In this case, the reference signal may be referred to as TRS.

In the first embodiment, the control region R1 may be a region notified, when the base station 100 has a cell operated in the general frequency band different from the specific frequency band, to the terminal 200 from the cell operated in the general frequency band. Alternatively, the control region R1 may be a region notified, when there is another base station capable of dual connectivity communication with the terminal 200 besides the base station 100, from the other base station to the terminal 200.

In the first embodiment, the controller 160 performs a carrier-sense for a part of or a whole of the specific frequency band to specify an available candidate region R2 that is a candidate for the data region R2, instructs to the terminal 200 the carrier-sense for the available candidate region, and determines the data region R2 on the basis of the available region specified by the carrier-sense in the terminal 200.

(Configuration of Terminal)

FIG. 8 is a block diagram of the terminal 200.

As illustrated in FIG. 8, the terminal 200 includes an antenna 201, a radio unit 210, a baseband unit 220, a user interface (I/F) 240, a storage unit 250, and a controller 260. The radio unit 210 and the baseband unit 220 configure a transceiver 230.

The antenna 201 and the radio unit 210 are used for exchanging a radio signal. The antenna 201 may be configured by a plurality of antennas. The baseband unit 220 converts the baseband signal (transmission signal) output from the controller 260, into the radio signal and outputs the resultant signal to the radio unit 210. Further, the baseband unit 220 converts the radio signal received by the radio unit 210 into the baseband signal (reception signal), and outputs the resultant signal to the controller 260.

The I/F 240 is an interface with a user carrying the terminal 200, and includes, for example, a display, a microphone, a speaker, and various buttons. The user I/F 240 outputs, in response to an operation from a user, a signal indicating a content of the operation to the controller 260.

The storage unit 250 is configured by a memory, for example, and stores a program executed by the controller 260 and information used for a process by the controller 260. The controller 260 is configured by a processor, for example, and executes the program stored in the storage unit 250 to perform various types of processes.

An operation overview of the terminal 200 thus configured will be described. In the first embodiment, the terminal 200 performs the radio communication with the base station 100 in the specific frequency band in which the frequency sharing is permitted among a plurality of communication operators or a plurality of radio communication systems.

A part of the frequency region within the specific frequency band is set as the control region R1. Further, by the carrier-sense in the specific frequency band, the data region R2 for user data transmission is determined from the frequency region different from the part of the frequency region within the specific frequency band.

The transceiver 230, transmits or receives, in the data region R2, the terminal-specific data control information for individually controlling the user data transmission of each terminal 200 within the control region R1.

The terminal-specific data control information includes the downlink control information (DCI). The downlink control information includes resource allocation information, modulation and coding scheme (MCS) information, redundant version information, and a new data indicator within the data region R2. The transceiver 230 receives, in the control region R1, the downlink control information.

Further, the terminal-specific data control information also includes the uplink control information (UCI). The uplink control information includes an acknowledgment (ACK/NACK) response to the user data transmitted in the data region R2, and channel state information (CSI) about the data region R2. The transceiver 230 transmits, in the control region R1, the uplink control information. A period during which the downlink control information is received and a period during which the uplink control information is transmitted are set in time division.

In the first embodiment, the transceiver 230 receives, in the control region R1, the synchronization signal, and receives, in the data region R2, the terminal-specific reference signal.

In the first embodiment, in the data region R2, the transceiver 230 receives the cell-specific reference signal at a predetermined time interval or omits the reception of the cell-specific reference signal. The transmission of the cell-specific reference signal may perform only from a predetermined antenna of the base station 100.

In the first embodiment, when the base station 100 has a cell operated in the general frequency band different from the specific frequency band, the control region R1 may be a region notified from the cell operated in the general frequency band to its own terminal 200. Alternatively, when there is another base station capable of dual connectivity communication with the base station 100 besides the terminal 200, the control region R1 may be a region notified from the other base station to its own terminal 200.

In the first embodiment, when being instructed from the base station 100 the carrier-sense for the available candidate region specified by the base station 100, the controller 260 performs the carrier-sense for the available candidate region and notifies the base station 100 of a result of the available candidate region.

(Operation Flow)

Next, an operation flow of the LTE system according to the first embodiment will be described.

(1) Operation Related to Determination of Data Region.

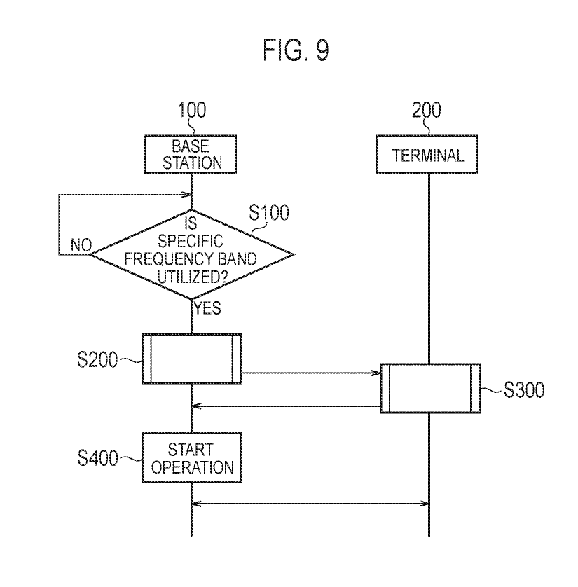

FIG. 9 is a flowchart illustrating an operation related to a determination of the data region R2.

As illustrated in FIG. 9, in step S100, the base station 100 determines whether or not it is necessary to utilize the specific frequency band. Determination as to whether or not it is necessary to utilize is performed by a core network and may be notified to the base station 100. Alternatively, another base station (such as the macro base station) may determine on the necessity, and notify the base station 100. Alternatively, the base station 100 itself may make the determination.

When the base station 100 determines that it is necessary to utilize the specific frequency (step S100: YES), the base station 100 implements, in step S200, an operation related to the carrier-sense.

In step S300, the terminal 200 implements the operation related to the carrier-sense.

In step S400, the base station 100 starts, in response to the result of step S200 and step S300, the operation of the cell operable in the specific frequency band.

(1.1) Base Station Operation Related to Carrier-Sense

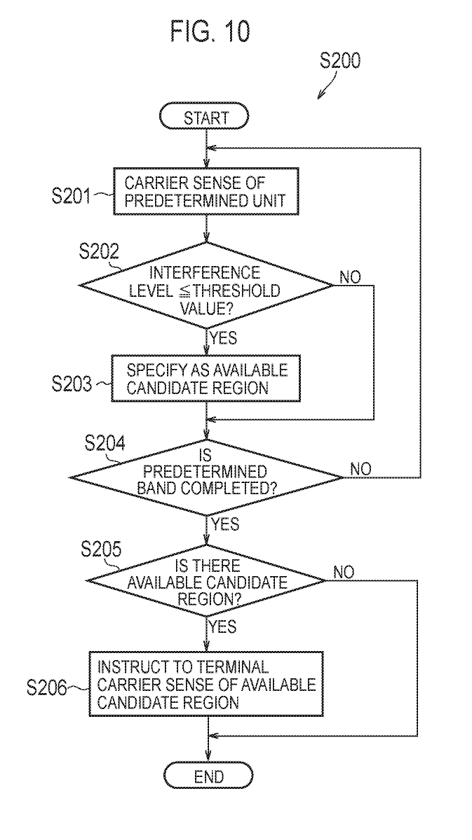

FIG. 10 is a flowchart illustrating a detail of the operation (that is, step S200 of FIG. 9) of the base station 100 related to the carrier-sense.

As illustrated in FIG. 10, in step S201, the base station 100 performs, for each predetermined unit, sensing on the radio resource included in the specific frequency band.

In step S202, the base station 100 determines whether or not the interference level in the radio resource of a predetermined unit is equal to or less than a threshold value.

When the interference level of the predetermined unit is equal to or less than the threshold value (step S202: YES), the base station 100 specifies, in step S203, the region as the available candidate region. On the other hand, when the interference level is equal to or more than the threshold value, the base station 100 specifies the region as an unavailable candidate region.

In step S204, the base station 100 determines whether or not the carrier-sense for a band of the specific frequency band is completed. When the carrier-sense is not completed (step S204: NO), the operation from step S201 to step S203 is repeated.

On the other hand, when the carrier-sense is completed (step S204: YES), in step S205, the base station 100 determines whether or not presence or absence of the available candidate region.

When there is the available candidate region (step 205: YES), in step S206, the base station 100 instructs to the terminal 200 the carrier-sense for the available candidate region. When there is no candidate region (step S205: NO), the process is ended.

(1.2) Terminal Operation Related to Carrier-Sense

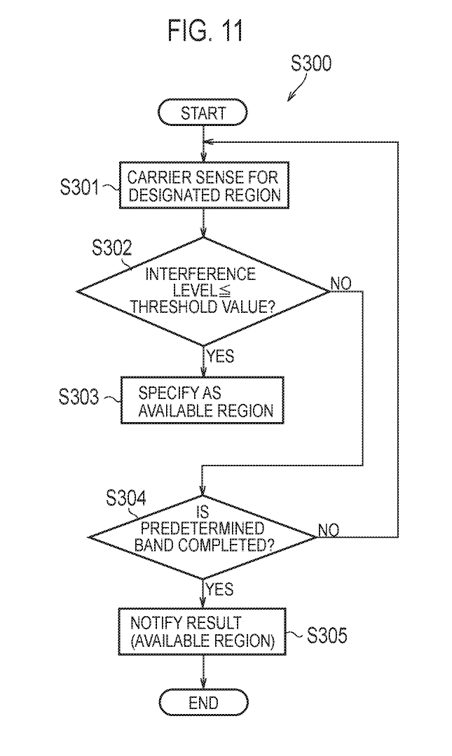

FIG. 11 is a flowchart illustrating a detail of the operation (that is, step S300 of FIG. 9) of the terminal 200 related to the carrier-sense.

In step S301, the terminal 200 in which the carrier-sense is instructed by the base station 100, performs the sensing, for each predetermined unit, on the radio resource included in the region (available candidate region) designated by the base station 100.

In step S302, the terminal 200 determines whether or not the interference level in the radio resource in a predetermined unit is equal to or less than the threshold value.

When the interference level of the predetermined unit is equal to or less than the threshold value (step S302: YES), in step S303, the terminal 200 specifies the region as the available region.

On the other hand, when the interference level of the predetermined unit exceeds the threshold value (step S302: NO), in step S304, the terminal 200 determines whether or not the carrier-sense is completed in the entire designated available region. When the carrier-sense is not completed (step S304: NO), the operation from step S301 to the S303 is repeated.

When the carrier-sense is completed (step S304: YES), in step S305, the terminal 200 transmits a result of the sensing result to the base station 100. When there is an available region, it is desired to notify detailed information such as an available range. The terminal 200 ends the present process upon completion of the sensing result.

(2) Operation Related to End of Data Region

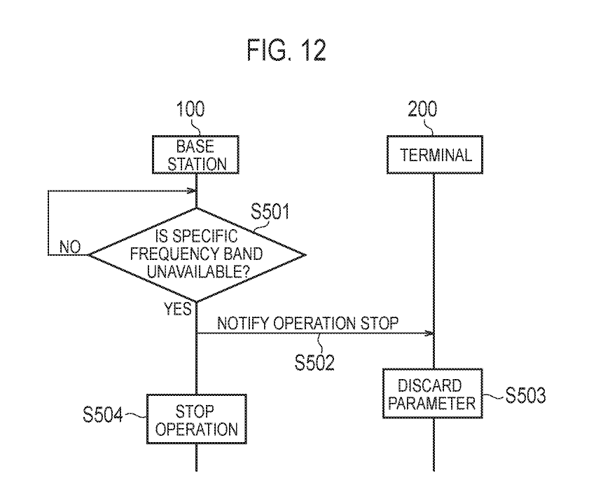

FIG. 12 is a flowchart illustrating an operation related to and end of use of the data region.

As illustrated in FIG. 12, in step S501, the base station 100 determines whether or not the use of at least one data region R2, among the data regions R2 currently in use, is unavailable. For example, the base station 100 may provide an opportunity to perform an OFF period once within a predetermined time period after a start of the operation, execute the carrier-sense in the OFF period, and regularly determine whether or not the utilized frequency is continuously available. Further, the base station 100 may execute the terminal 200 in communication with itself to execute the carrier-sense by using the OFF period. In this case, the OFF period is realized by setting ABS (Almost Blank Subframe), for example.

When the base station determines that the use of the data region R2 is unavailable (step S501: YES), in step S502, the base station 100 determines to stop the user data transmission using the data region R2, and broadcasts the terminal 200 to stop the operation of the data region R2. The broadcast may be repeated for a predetermined number of times.

In step S503, the terminal 200 that receives the broadcast information discards a parameter held for the user data reception that involves the data region R2.

In step S504, the base station 100 stops the operation of the data region R2.

It is noted that in the present operation flow, the base station 100 broadcasts the stop of the operation of the data region R2; however, this is not limiting. For example, the base station 100 may individually transmit a new parameter for each user by using the data region R2 so as to notify the unavailability of the continuous use of the data region R2.

Further, from a measurement report from the terminal 200 in communication with the base station 100 and from SINR of the signal received from the terminal 200, it is possible to determine to adjust transmission power and reception power applied to the communication with the terminal 200, or possible to determine that the utilized frequency is not usable to the communication with the terminal 200. The base station 100 may control so that the terminal 200 in which it is determined not to be able to utilize the utilized frequency does not use the frequency.

### Second Embodiment

A second embodiment will be described while focusing on a difference from the first embodiment, below. The second embodiment relates to a method of determining the control region R1.

In the second embodiment, the control region R1 is shared by the plurality of base stations 100 operated by an identical communication operator. The controller 160 of the base station 100 performs, on the basis of a result of the carrier-sense in the control region R1, a time-division setting so that the control region R1 of its own base station 100 does not overlap, along a time axis, with the control area of another base station.

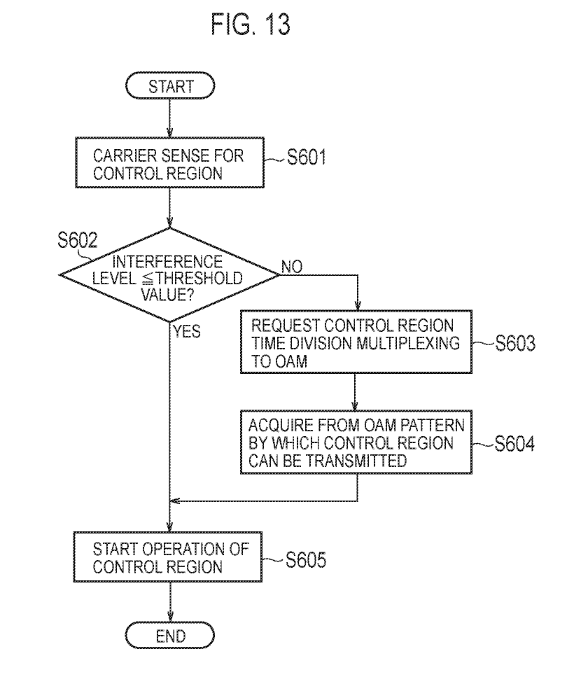

FIG. 13 is a flowchart illustrating the method of determining the control region R1 according to the second embodiment. FIG. 13 exemplifies a case that the start of the operation of the cell operable in the specific frequency band provided in the base station 100 is determined. The start of the operation is determined in the core network and notified to the base station 100. Alternatively, the start of the operation may be determined in the macro base station 101 and notified to the base station 100, and may also be determined by the base station 100 itself.

As illustrated in FIG. 13, in step S601, the base station 100 implements the carrier-sense for the frequency region allocated with the control region R1. The frequency region allocated with the control region R1 is a previously determined region. Alternatively, the frequency region may be determined by the core network or the macro base station 101 and notified to the base station 100, and it may also be determined by the base station 100 itself.

In step S602, the base station 100 determines whether or not the interference level is equal to or less than a threshold value. The threshold value is a previously determined value. Alternatively, the frequency region may be determined by the core network or the macro base station 101 and notified to the base station 100, and it may also be determined by the base station 100 itself. When the interference level is equal to or less than the threshold value (step S602: YES), the operation of the control region R1 is started (step S605).

When the interference level is not equal to or less than the threshold value (step S602: NO), in step S603, a time division multiplexing of the control region R1 is requested to the core network (OAM 400). The core network determines a time division pattern of the control region R1 and notifies a related base station.

In step S604, the base station 100 acquires the time division pattern of the control region R1. The base station 100 starts, on the basis of the acquired information, the operation of the control region R1.

It is noted that in the present operation flow, the request for the time division multiplexing of the control region R1 is transmitted to the core network; however, this is not limiting. For example, the request may also be transmitted to the core network and also to a peripheral base station, and may also be transmitted only to the peripheral base station. The peripheral base station may either be a macro base station or a small base station. The peripheral base station that receives the request may determine the time division pattern of the control region and notify the related base station.

Further, when the control region R1 is time divided, there may be a period in which the base station 100 is not capable of transmitting the data control information via the control region R1. In order to transmit the user data in the data region R2 during this period, the base station 100 is capable of transmitting the data control information of the data region R2 during this time period via the control region R1. Specifically, the base station 100 uses a multi-subframe scheduling or a cross subframe scheduling to transmit the user data. The multi-subframe scheduling is a technique of enabling allocation, with one piece of data control information, of the data region R2 of consecutive or fixed pattern subframes.

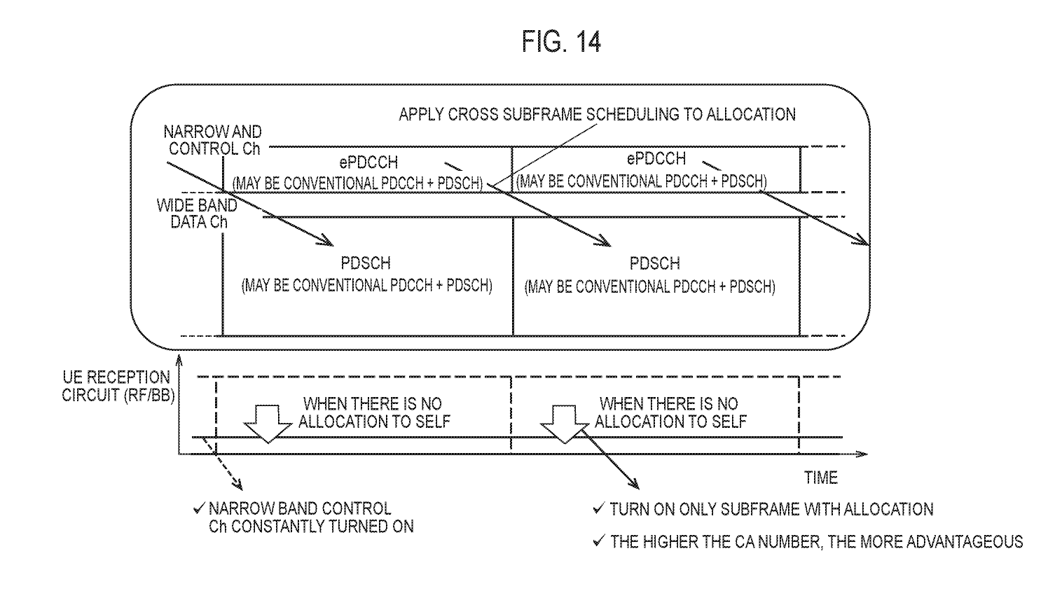

FIG. 14 is a diagram illustrating an operation related to the cross subframe scheduling.

As illustrated in FIG. 14, the terminal 200 monitors a narrow-band control region R1. Upon determination that there is a resource allocation to itself in the control region R1, the terminal 200 receives, in a subframe subsequent to the control region R1, the user data transmitted in the data region R2 that is frequency-divided from the control region R1. When the present process is applied, it is only necessary for the terminal 200 to receive the data region R2 in the subframe only in which there is the allocation, and thus, it is possible to obtain a power saving effect. It is noted that compared to the control region R1, usually, the data region R2 is believed to secure a sufficiently wide bandwidth.

It is noted that as another method of transmitting the data control information in the period, other various methods are possible such as a method of using the control region of a cell operated in a band other than the specific frequency band of the base station 100, or a method of using the control region of another base station (macro base station or the like).

In addition, in the present embodiment, the request for the time division multiplexing of the control region R1 is transmitted according to the result of the carrier-sense; however, this is not limiting. For example, the base station 100 may determine re-allocation of the control region R1 according to the result of the carrier-sense, and may adjust the transmission power of the control region R1. When the transmission power of the control region R1 is adjusted, the base station 100 notifies an existing terminal of at least the adjusted reference signal transmission power. Further, depending on the determination of the re-allocation, the request may be made to the core network or to the macro base station 101.

### Other Embodiments

Although not particularly mentioned in the above-described embodiment, the base station 100 may set, at a start time of communication, the CSI-RS to the data region R2 where the data exchange is performed with the terminal 200. The CSI-RS is configured by NZP (Non-Zero Power)-CSI-RS in which a predetermined known signal is transmitted, and ZP (Zero Power)-CSI-RS in which no signal is transmitted. The base station 100 may ensure that the terminal 200 allocated with the CSI-RS uses the ZP-CSI-RS to measure the interference amount of the utilized frequency and notifies the measurement result. Further, it may be possible to ensure that the terminal 200 measures the NZP-CSI-RS and notifies the measurement result represented by the CSI-RS-RSRP and CSI information and the like. It is noted that in addition to the NZPCSI-RS or instead of the NZP-CSI-RS, the base station 100 may transmit the cell-specific reference signal (CRS) to ensure that the terminal 200 measures the cell-specific reference signal and notifies the measurement result represented by CSI-RS-RSRP and CSI information and the like. The cell-specific reference signal may include the TRS in addition to the CRS. Further, the base station 100 may ensure that “another terminal” connected to itself and not using the frequency is notified of the information about the ZP-CSIRS and is caused to use the ZP-CSI-RS to execute the carrier-sense. The base station 100 may ensure that another terminal in which the use of the frequency is determined to be available as a result of the carrier-sense is allocated, by using part of the ZP-CSI-RS, with the NZP-CSI-RS dedicated to the other terminal and the other terminal is caused to notify the measurement result represented by CSI-RS-RSRP and CSI information and the like. It is noted that as described above, the cell-specific reference signal may be used instead of the NZP-CSI-RS.

Although not particularly mentioned in the embodiment, it is possible to provide a program for causing a computer to execute each process performed by the terminal 200. Further, the program may be recorded on a computer-readable medium. When the computer-readable medium is used, it is possible to install the program in a computer. Here, the computer-readable medium recording therein the program may be a non-transitory recording medium. The non-transitory recording medium is not particularly limited; the examples thereof may be a recording medium such as a CD-ROM and a DVD-ROM.

Alternatively, a chip, which includes a memory for storing the program for performing each process executed by the terminal 200, and a processor for executing the program stored in the memory, may be provided.

1. A base station configured to perform radio communication with a plurality of user terminals in a specific frequency band in which frequency sharing is permitted among a plurality of communication operators or a plurality of radio communication systems, wherein a part of a frequency region within the specific frequency band is set as a control-only region, the base station comprises:
a controller configured to determine, by a carrier-sense in the specific frequency band, a data region for user data transmission, from a frequency region different from the part of the frequency region within the specific frequency band; and
a transceiver configured to transmit or receive, in the control-only region, terminal-specific data control information for individually controlling a user data transmission of each user terminal within the data region.

2. The base station according to claim 1, wherein
the terminal-specific data control information includes downlink control information,
the downlink control information includes resource allocation information, modulation and coding scheme information, redundant version information, and a new data indicator within the data region, and
the transceiver transmits the downlink control information in the control-only region.

3. The base station according to claim 2, wherein
the terminal-specific data control information further includes uplink control information,
the uplink control information includes an acknowledgment to user data transmitted within the data region and channel state information on the data region,
the transceiver receives the uplink control information in the control-only region, and
a period during which the downlink control information is transmitted and a period during which the uplink control information is received are set in time division.

4. The base station according to claim 1, wherein
the transceiver transmits a synchronization signal in the control-only region, and transmits a terminal-specific reference signal in the data region.

5. The base station according to claim 1, wherein
in the data region, the transceiver transmits a cell-specific reference signal at a predetermined time interval or omits the transmission of the cell-specific reference signal,
the predetermined time interval is a time interval shorter than a transmission time interval of the cell-specific reference signal in a base station configured to perform radio communication in a general frequency band different from the specific frequency band.

6. The base station according to claim 1, wherein
the control-only region is a region notified, when the base station includes a cell operated in a general frequency band different from the specific frequency band, from the cell to a user terminal or a region notified, when there is, in addition to the base station, another base station capable of dual connectivity communication with a user terminal, from the other base station to a user terminal.

7. The base station according to claim 1, wherein
the controller performs a carrier-sense for a part or a whole of the specific frequency band to specify an available candidate region that is a candidate for the data region,
the controller instructs, to a user terminal, carrier-sense for the available candidate region, and
the controller determines, on the basis of the available region specified by the carrier-sense in the user terminal, the data region.

8. The base station according to claim 1, wherein
the part of the frequency region constituting the control-only region is shared among a plurality of base stations operated by an identical communication operator, and
the controller performs, on the basis of a result of the carrier-sense in the part of the frequency region, a time-division setting so that a control-only region of the base station does not overlap, along a time axis, with a control-only region of another base station.

9. A user terminal configured to perform radio communication with a base station in a specific frequency band in which frequency sharing is permitted among a plurality of communication operators or a plurality of radio communication systems, wherein
a part of a frequency region within the specific frequency band is set as a control-only region,
a data region for user data transmission is determined, by a carrier-sense in the specific frequency band, from a frequency region different from the part of the frequency region within the specific frequency band, and
the user terminal includes a transceiver configured to transmit or receive, in the control-only region, terminal-specific data control information for individually controlling a user data transmission of each user terminal within the data region.

10. The user terminal according to claim 9, wherein
the terminal-specific data control information includes downlink control information,
the downlink control information includes resource allocation information, modulation and coding scheme information, redundant version information, and a new data indicator within the data region, and
the transceiver receives the downlink control information in the control-only region.

11. The user terminal according to claim 10, wherein
the terminal-specific data control information further includes uplink control information,
the uplink control information includes an acknowledgment to user data transmitted within the data region and channel state information on the data region,
the transceiver transmits the uplink control information in the control-only region, and
a period during which the downlink control information is received and a period during which the uplink control information is transmitted are set in time division.

12. The user terminal according to claim 9, wherein
the transceiver receives a synchronization signal in the control-only region, and receives a terminal-specific reference signal in the data region.

13. The user terminal according to claim 9, wherein
in the data region, the transceiver receives a cell-specific reference signal at a predetermined time interval or omits the reception of the cell-specific reference signal,
the predetermined time interval is a time interval shorter than a transmission time interval of the cell-specific reference signal in a base station configured to perform radio communication in a general frequency band different from the specific frequency band.

14. The user terminal according to claim 9, wherein
the control-only region is a region notified, when the base station includes a cell operated in a general frequency band different from the specific frequency band, from the cell to its own user terminal or a region notified, when there is, in addition to the base station, another base station capable of dual connectivity communication with the user terminal, from the other base station to its own user terminal.

15. The user terminal according to claim 9, wherein
the controller performs, when being instructed, from the base station, a carrier-sense for an available candidate region specified by the base station, the carrier-sense for the available candidate region, and notifies the base station of a result of the carrier-sense for the available candidate region.
